(19) United States
(12) Patent Application Publication
(10) Pub. No.: US 2010/0064291 A1
(43) Pub. Date: Mar. 11, 2010

(54) System and Method for Reducing Execution Divergence in Parallel Processing Architectures

(75) Inventors: Timo AILA, Helsinki (FI); Samuli Laine, Helsinki (FI); David Luebke, Charlottesville, VA (US); Michael Garland, Lake Elmo, MN (US); Jared Hoberock, Nevada, MO (US)

Correspondence Address: PATTERSON & SHERIDAN, L.L.P., 3040 POST OAK BOULEVARD, SUITE 1500, HOUSTON, TX, 77056, US

(73) Assignee: Nvidia Corporation, Santa Clara, CA (US)

(21) Appl. No.: 12/204,974

(22) Filed: Sep. 5, 2008

(51) Int. Cl. G06F 9/46

(52) U.S. Cl. 718/104

(57) ABSTRACT

A method for reducing execution divergence among a plurality of threads executable within a parallel processing architecture includes an operation of determining, among a plurality of data sets that function as operands for a plurality of different execution commands, a preferred execution type for the collective plurality of data sets. A data set is assigned from a data set pool to a thread which is to be executed by the parallel processing architecture, the assigned data set being of the preferred execution type, whereby the parallel processing architecture is operable to concurrently execute a plurality of threads, the plurality of concurrently executable threads including the thread having the assigned data set. An execution command for which the assigned data functions as an operand is applied to each of the plurality of threads.

### FIELD OF THE INVENTION

The present invention relates to parallel processing, and more particularly to systems and methods for reducing execution divergence in parallel processing architectures.

### BACKGROUND

Processor cores of current graphics processing units (GPUs) are highly parallel multiprocessors that execute numerous threads of program execution (“threads” hereafter) concurrently. Threads of such processors are often packed together into groups, called warps, which are executed in a single instruction multiple data (SIMD) fashion. The number of threads in a warp is referred to as SIMD width. At any one instant, all threads within a warp may be nominally applying the same instruction, each thread applying the instruction to its own particular data values. If the processing unit is executing an instruction that some threads do not want to execute (e.g. due to conditional statement, etc.), those threads are idle. This condition, known as divergence, is disadvantageous as the idling threads go unutilized, thereby reducing total computational throughput.

There are several situations where multiple types of data need to be processed, each type requiring computation specific to it. One example of such situation is processing elements in a list which contains different types of elements, each element type requiring different computation for processing. Another example is a state machine that has an internal state that determines what type of computation is required, and the next state depends on input data and the result of the computation. In all such cases, SIMD divergence is likely to cause reduction of total computational throughput.

One application in which parallel processing architectures find wide use is in the fields of graphics processing and rendering, and more particularly, ray tracing operations. Ray tracing involves a technique for determining the visibility of a primitive from a given point in space, for example, an eye, or camera perspective. Primitives of a particular scene which are to be rendered are located via a data structure, such as a grid or a hierarchical tree. Such data structures are generally spatial in nature but may also incorporate other information (angular, functional, semantic, and so on) about the primitives or scene. Elements of this data structure, such as cells in a grid or nodes in a tree, are referred to as “nodes”. Ray tracing involves a first operation of “node traversal,” whereby nodes of the data structure are traversed in a particular manner in an attempt to locate nodes having primitives, and a second operation of “primitive intersection,” in which a ray is intersected with one or more primitives within a located node to produce a particular visual effect. The execution of a ray tracing operation includes repeated application of these two operations in some order.

Execution divergence can occur during the execution of ray tracing operations, for example, when some threads of the warp require node traversal operations and some threads require primitive intersection operations. Execution of an instruction directed to one of these operations will result in some of the threads being processed, while the other thread remaining idle, thus generating execution type penalties and under-utilization of the SIMD.

Therefore, a system and method for reducing execution divergence in parallel processing architectures is needed.

### SUMMARY

A method for reducing execution divergence among a plurality of threads concurrently executable by a parallel processing architecture includes an operation of determining, among a plurality of data sets that function as operands for a plurality of different execution commands, a preferred execution type for the collective plurality of data sets. A data set is assigned from a data set pool to a thread which is to be executed by the parallel processing architecture, the assigned data set being of the preferred execution type, whereby the parallel processing architecture is operable to concurrently execute a plurality of threads, the plurality of threads including the thread having the assigned data set. An execution command for which the assigned data functions as an operand is applied to each of the plurality of threads.

### BRIEF DESCRIPTION OF THE DRAWINGS

FIG. 1 illustrates an exemplary method of reducing the execution divergence among a plurality of threads executed by a parallel processing architecture in accordance with the present invention.

FIG. 2 illustrates a first exemplary embodiment of the method of FIG. 1, in which a shared pool and one or more threads of the parallel processing architecture include data sets of different execution types.

FIG. 3 illustrates an exemplary method of the embodiment shown in FIG. 2.

FIG. 4 illustrates a second exemplary embodiment of the method of FIG. 1, in which separate memory stores are implemented for storing data sets of distinct execution types or identifiers thereof.

FIG. 5 illustrates an exemplary method of the embodiment shown in FIG. 4.

FIG. 6 illustrates an exemplary system operable to perform the operations illustrated in FIGS. 1-5.

### DETAILED DESCRIPTION OF EXEMPLARY EMBODIMENTS

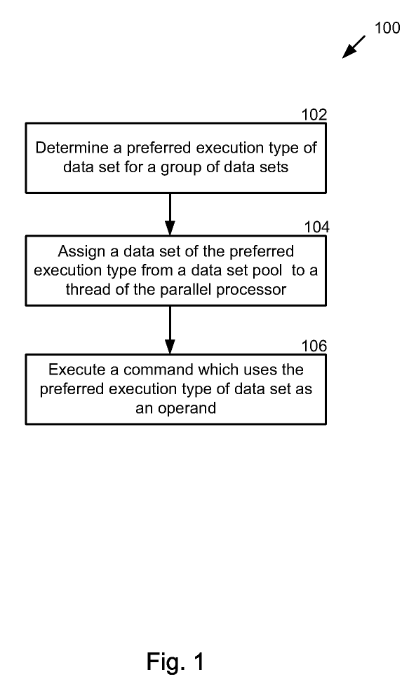

FIG. 1 illustrates an exemplary method 100 of reducing the execution divergence among a plurality of threads concurrently executable by a parallel processing architecture in accordance with the present invention. From among a plurality of data sets assignable to threads of a parallel processing architecture, the data sets functioning as operands for different execution commands, at 102 a preferred execution type is determined for the collective plurality of data set. At 104, one or more data sets which are of the preferred execution type are assigned from a pool of data sets to respective one or more threads which are to be executed by the parallel processing architecture. The parallel processing architecture is operable to concurrently execute a plurality of threads, such plurality of threads including the one or more threads which have been assigned data sets. At 106, an execution command, for which the assigned data set functions as an operand, is applied to plurality of threads to produce a data output.

In an exemplary embodiment, the parallel processing architecture is a single instruction multiple data (SIMD) architecture. Further exemplary, the pool is a local shared memory or register file resident within the parallel processing architecture. In a particular embodiment shown below, the determination of a preferred data set execution type is based upon the number of data sets resident in the pool and within the parallel processing architecture. In another embodiment, the determination of a preferred data set execution type is based upon the comparative number of data sets resident in two or more memory stores, each memory store operable to store an identifier of data sets stored in a shared memory pool, each memory store operable to store identifiers of one particular execution type. Further particularly, full SIMD utilization can be ensured when the collective number of available data sets is at least M(N−1)+1, where M is the number of different execution types and N is the SIMD width of the parallel processing architecture.

In an exemplary application of ray tracing, a data set is a “ray state,” the ray state composed of a “ray tracing entity” in addition to state information about the ray tracing entity. A “ray tracing entity” includes a ray, a group of rays, a segment, a group of segments, a node, a group of nodes, a bounding volume (e.g., a bounding box, a bounding sphere, an axis-bounding volume, etc.), an object (e.g., a geometric primitive), a group of objects, or any other entity used in the context of ray tracing. State information includes a current node identifier, the closest intersection so far, and optionally a stack in an embodiment in which a hierarchical acceleration structure is implemented. The stack is implemented when a ray intersects more that one child node during a node traversal operation. Exemplary, the traversal proceeds to the closest child node (a node further away from the root compared with a parent node), and the other intersected child nodes are pushed to the stack. Further exemplary, a data set of a preferred execution type is a data set used in performing a node traversal operation or a primitive intersection operation.

Exemplary embodiments of the invention are now described in terms of an exemplary application for ray tracing algorithms. The skilled person will appreciate that the invention is not limited thereto and extends to other fields of application as well.

### Pool and Processor Thread(s) Include Data Sets of Different Execution Types

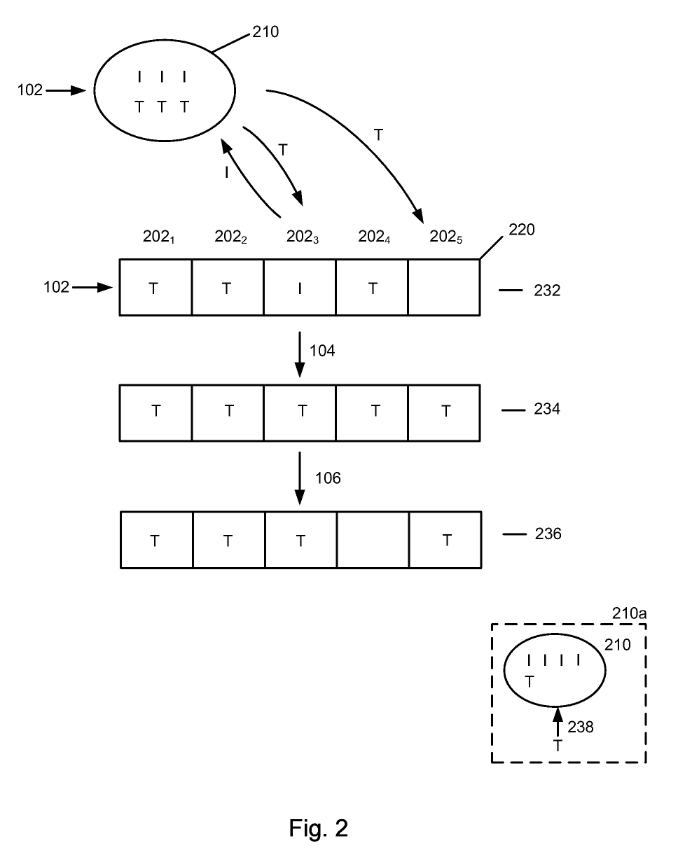

FIG. 2 illustrates a first exemplary embodiment of the invention, in which a shared pool and one or more threads of the parallel processing architecture include data sets of different execution types.

The parallel processing architecture used is a single instruction multiple data architecture (SIMD). The data sets are implemented as “ray states” described above, although any other type of data set may be used in accordance with the invention.

Each ray state is characterized as being one of two different execution types: ray states which are operands in primitive intersection operations are denoted as “I” ray states, and ray states which are operands in node traversal operations are illustrated as “T” ray states. Ray states of both execution types populate the shared pool 210, and the SIMD 220 as shown, although in other embodiments, either the pool 210 or the SIMD may contain ray state(s) of only one execution type. The SIMD 220 is shown as having 5 threads 202₁-202₅ for purposes of illustration only, and the skilled person will appreciate that any number of threads could be employed, for example, 32, 64, or 128 threads. Ray states of two execution types are illustrated, although ray states of three or more execution types may be implemented in an alternative embodiment under the invention.

Operation 102 in which a preferred execution type is determined, is implemented as a process of counting, for each execution type, the collective number of ray states which are resident in the pool 210 and the SIMD 220, the SIMD 220 having at least one thread which maintains a ray state (reference indicia 102 in FIG. 2 indicating operation 102 is acting upon pool 210 and SIMD 220). The execution type representing the largest collective number of data sets is deemed the preferred execution type (e.g., node traversal) for the execution operation of the SIMD 220. In the illustrated embodiment, the number of “T” ray states (six) is higher than the number of “I” ray states (four) in stage 232 of the process, and accordingly, the preferred execution type are ray states employed with node traversal operations, and a command to perform a node traversal computation will be applied at operation 106.

The number of ray states resident within the SIMD 220 may be weighted (e.g., with a factor of greater than one) so as to add bias in how the preferred execution type is determined. The weighting may be used to reflect that ray states resident within the SIMD 210 are preferred computationally over ray states which are located within the pool 210, as the latter requires assignment to one of the threads 202₁-202ₙ within the SIMD 210. Alternatively, the weighting may be applied to the pool-resident ray states, in which case the applied weighting may be a factor lower than one (assuming the SIMD-resident ray states are weighted as a factor of one, and that processor-resident ray states are favored).

The “preferred” execution type may be defined by a metric other than determining which execution type represents the largest number (possibly weighted, as noted above) among the different execution types. For example, when two or more execution types have the same number of associated ray states, one of those execution types may be defined as the preferred execution type. Still alternatively, a ray state execution type may be pre-selected as the preferred execution type at operation 102 even if it does not represent the largest number of the ray states. Optionally, the number of available ray states of different execution types may be limited to the SIMD width when determining the largest number, because the actual number of available ray states may not be relevant to the decision if it is greater than or equal to the SIMD width. When the number of available ray states are sufficiently numerous for each execution type, the “preferred” type may be defined as the execution type of those ray states which will require the least time to process.

Operation 104 includes the process of assigning one or more ray states from pool 210 to respective one or more threads in the SIMD 220. This process is illustrated in FIG. 2, in which thread 202₃ includes a ray state of a non-preferred execution type, i.e., a ray state operable with a primitive intersection operation when the preferred execution type is a ray state operable with a node traversal operation. The non-preferred data set (ray state “I”) is transferred to pool 210, and replaced by a preferred-execution type data set (ray state “T”). Further exemplary, one or more of the threads (e.g., 202₅ at stage 232) may be inactive (i.e., terminated), in which case such threads may not include a ray state at stage 232. When the pool 210 includes a sufficient number of ray states, operation 104 further includes assigning a ray state to a previously terminated thread. In the illustrated embodiment a ray state “T” is assigned to thread 202₅. In another embodiment in which an insufficient number of ray states are stored in the pool 210, one or more terminated threads may remain empty. Upon completion of operation 104, the SIMD composition is as shown at stage 234, in which two node traversal ray states have been retrieved from the pool 210, and one primitive intersection ray state has been added thereto. Thus, the pool 210 includes four “I” ray states and only one “T” ray state.

Full SIMD utilization is accomplished when all SIMD threads implement a preferred type ray state, and the corresponding execution command is applied to the SIMD. The minimum number of ray states needed to assure full SIMD utilization, per execution operation, is:

M(N−1)+1

wherein M is the number of different execution types for the plurality of ray states, and N is the SIMD width. In the illustrated embodiment, M=2 and N=5, thus the total number of available ray states needed to guarantee full SIMD utilization is nine. A total of 10 ray states are available in the illustrated embodiment, so full SIMD utilization is assured.

Operation 106 includes applying one execution command to each of the parallel processor threads, the execution command intended to operate on the ray states of the preferred execution type. In the foregoing exemplary ray tracing embodiment, a command for performing a node traversal operation is applied to each of the threads. The resulting SIMD composition is shown at stage 236.

Each thread employing the preferred execution ray states are concurrently operated upon by the node traversal command, and data therefrom output. Each executed thread advances one execution operation, and a resultant ray state appears for each. Typically, one or more data values included within the resultant ray state will have undergone a change in value upon execution of the applied instruction, although some resultant ray states may include one or more data values which remain unchanged, depending upon the applied instruction, operation(s) carried out, and the initial data values of the ray state. While no such threads are shown in FIG. 2, threads which have non-preferred execution type ray states (e.g., a ray state operable with primitive intersection operation in the illustrated embodiment) remain idle during the execution process. Once operation 106 is completed, the operations of determining which of the ray states is to be preferred (operation 102), assigning such data sets to the processor threads (operation 104), and applying an execution command for operating upon the data sets assigned to the threads (operation 106) may be repeated.

Further exemplary, two or more successive execution operations can be performed at 106, without performing operations 102 and/or 104. Performing operation 106 two or more times in succession (while skipping operation 102, or operation 104, or both) may be beneficial, as the preferred execution type of subsequent ray states within the threads may not change, and as such, skipping operations 102 and 104 may be computationally advantageous. For example, commands for executing two node traversal operations may be successively executed, if it is expected that a majority of ray states in a subsequent execution operation are expecting node traversal operations. At stage 236, for example, a majority of the illustrated threads (202₁-202₃ and 202₅, thread 202₄ has terminated) include resultant ray states for node traversal operations, and in such a circumstance, an additional operation 106 to perform a node traversal operation without operations 102 and 104 could be beneficial, depending on relative execution costs of operations 102, 104 and 106. It should be noted that executing operation 106 multiple times in succession decreases the SIMD utilization if one or more ray states evolve so that they require execution type other than the preferred execution type.

Further exemplary, the pool 210 may be periodically refilled to maintain a constant number of ray states in the pool. Detail 210a shows the composition of pool 210 after a new ray state is loaded into it at stage 238. For example, refilling can be performed after each execution operation 106, or after every nth execution operation 106. Further exemplary, new ray states may be concurrently deposited in the pool 210 by other threads in the system. One or more ray states may be loaded into the pool 210 in alternative embodiments as well.

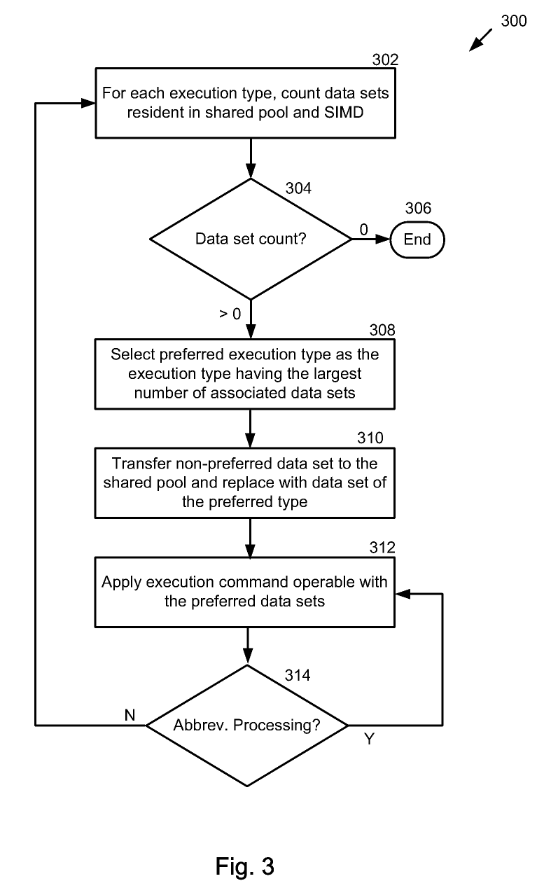

FIG. 3 illustrates an exemplary method of the embodiment shown in FIG. 2. Operations 302, 304, 306 and 308 represent a specific implementation of operation 102, whereby for each execution type, the number of data sets which are resident within the SIMD and the shared pool are counted. At 304, a determination is made as to whether the data set count for each of the SIMD and shared pool is greater than zero, i.e., if there are any data sets present in either the SIMD or shared pool. If not, the method concludes at 306. If there is at least one data set in one or both of the SIMD or shared pool, the process continues at 308, whereby the execution type which has the greatest support, i.e., which has the largest number of corresponding data sets, is selected as the preferred execution type. The operation at 308 may be modified by applying weighting factors to the processor-resident data sets and pool-resident data sets (a different weighting factor can be applied to each), as noted above. In such an embodiment in which two different execution types are implemented, the computation at 308 would be:

Score A=w1*[number of type A data sets in processor]+w2*[number of type A data sets in pool]

Score B=w3*[number of type B data sets in processor]+w4*[number of type B data sets in pool]

where Score A and Score B represent the weighted number of data sets stored within the processor and pool for execution types A and B, respectively. Weighting coefficients w1, w2, w3, w4 represent a bias/weighting factor for/against the processor-resident data sets each of execution types A and B, respectively. Operation 308 is implemented by selecting between the highest of Score A and Score B.

Operation 310 represents a specific implementation of operation 104, in which a non-preferred data set (data set not of the preferred execution type) is transferred to the shared pool, and a data set of the preferred execution type is assigned to the thread in its place. Operation 312 is implemented as noted in operation 106, whereby at least one execution command which is operable with the assigned data set, is applied to the threads. A resultant ray state is accordingly produced for each thread, unless the thread has terminated.

At operation 314, a determination is made as to whether abbreviated processing is to be performed in which a subsequent execution command corresponding to the preferred execution type is to be performed. If not, the method continues by returning to 302 for a further iteration. If so, the method returns to 312, where a further execution command is applied to the threads. The illustrated operations continue until all of the available data sets within the parallel processing architecture and shared pool are terminated.

### Separate Memory Stores for Distinct Execution Types

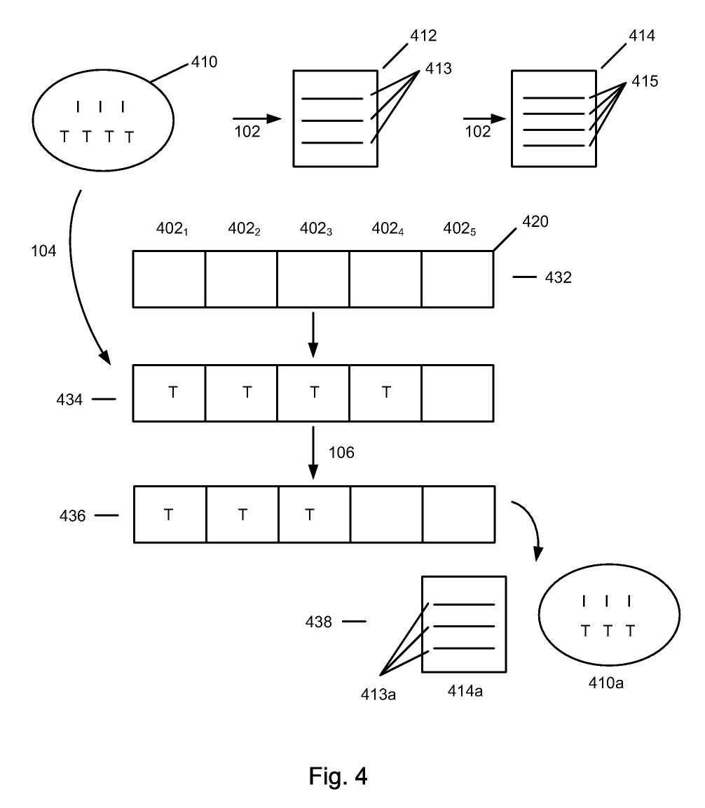

FIG. 4 illustrates a second exemplary embodiment of the invention, whereby separate memory stores are implemented for data sets of distinct execution types or identifiers thereof.

The data sets are implemented as “ray states” described above, although any other type of data set may be used in accordance with the invention. Each ray state is characterized as being one of two different execution types: the ray state is employed either in a node traversal operation or in a primitive intersection operation. However, three or more execution types may be defined in alternative embodiments of the invention. Ray states operable with primitive intersection and node traversal operations are illustrated as “I” and “T” respectively.

In the illustrated embodiment of FIG. 4, separate memory stores 412 and 414 are operable to store identifiers (e.g., indices) of the ray states, and the ray states themselves are stored in a shared pool 410. Two separate memory stores are illustrated, a memory store 412 operable to store indices 413 of ray states operable with primitive intersection operations (“I”), and a second memory store 414 operable to store indices 415 for ray states operable with the node traversal operations (“T”). Memory stores 412 and 414 may be first-in first-out (FIFO) registers, and the shared pool 410 is a high bandwidth, local shared memory. In another embodiment, the ray states “I” and “T” themselves are also stored in the memory stores (memory stores 412 and 414), e.g., in high speed hardware-managed FIFOs, or FIFOs which have accelerated access via special instructions. Two memory stores 412 and 414 corresponding to two different execution types are described in the exemplary embodiment, although it will be understood that three or more memory stores corresponding to three or more execution types may be employed as well. Memory stores 412 and 414 may be implemented as a non-ordered list, pool, or any other type of memory store in alternative embodiments of the invention. Implementation of the memory pools storing identifiers provides advantages, in that the process of counting the number of ray states is simplified. For example in the embodiment in which hardware-managed FIFOs are implemented as memory stores 412 and 414, the count of identifiers, and correspondingly, the number of ray states having a particular execution type, are available from each FIFO without requiring a counting process.

The embodiment of FIG. 4 is further exemplified by the threads 402₁-402₅ of the SIMD 420 having no assigned ray states in particular phases of its operation (e.g., at stage 432). Ray states are assigned at stage 434 prior to the execution operation 106, and thereafter assignments are removed from the threads 402₁-402₅ of the SIMD 420. The SIMD 420 is shown as having 5 threads 402₁-402₅ for purposes of illustration only, and the skilled person will appreciate that any number of threads could be employed, for example, 32, 64, or 128 threads.

Exemplary, operation 102 of determining the preferred execution type among I and T ray states of shared pool 410 is implemented by determining which of the memory store 412 or 414 has the largest number of entries. In the illustrated embodiment, memory store 414 stores four indices for ray states operable with node traversal operations contains the most entries, so its corresponding execution type (node traversal) is selected as the preferred execution type. In an alternative embodiment, a weighting factor may be applied to one of more of the entry counts if, for example, there is a difference in the speed or resources required in retrieving any of the ray states from the shared pool 410, or if the final image to be displayed will more quickly reach a satisfactory quality level by processing some ray states first. Further alternatively, the preferred execution type may be pre-defined, e.g., defined by a user command, regardless of which of the memory stores contain the largest number of entries. Optionally, the entry counts of different memory stores may be capped to the SIMD width when determining the largest number, because the actual entry count may not be relevant to the decision if it is greater than or equal to the SIMD width.

Operation 104 includes the process of fetching one or more indices from a “preferred” one of memory stores 412 or 414, and assigning the corresponding ray states to respective threads of the SIMD 420 for execution of the next applied instruction. In one embodiment, the “preferred” memory store is one which contains the largest number of indices, thus indicating that this particular execution type has the most support. In such an embodiment, memory store 414 includes more entries (four) compared to memory store 412 (three), and accordingly, the preferred execution type is deemed node traversal, and each of the four indices are used to assign corresponding “T” ray states from the shared pool 410 to respective SIMD threads 402₁-402₄. As shown at stage 434, only four “T” ray states are assigned to SIMD threads 402₁-402₄, as memory store 414 only contains this number of indices for the current execution stage of the SIMD. In such a situation, full SIMD utilization is not provided. As noted above, full SIMD utilization is assured when the collective number of available ray states is at least:

M(N−1)+1

wherein M is the number of different execution types for the plurality of ray states, and N is the SIMD width. In the illustrated embodiment, M=2 and N=5, thus the total number of available ray states needed to guarantee full SIMD utilization is nine. A total of seven ray states are available in the shared pool 410, so full SIMD utilization cannot be assured. In the illustrated embodiment, thread 402₅ is without an assigned ray state for the present execution operation.

Operation 106 is implemented by applying an execution command corresponding to the preferred execution type whose ray states were assigned in operation 104. Each thread 402₁-402₄ employing the preferred execution ray states are operated upon by the node traversal command, and data therefrom output. Each executed thread advances one execution operation, and a resultant ray state appears for each. As shown in stage 436, three resultant “T” ray states for 402₁-402₃ are produced, but ray state for thread 402₄ has terminated with the execution operation. Thread 402₅ remains idle during the execution process.

After operation 106, the resultant “T” ray states shown at stage 436 are written to the shared pool 414, and the indices corresponding thereto are written to memory store 412. In a particular embodiment, the resultant ray states overwrite the previous ray states at the same memory location, and in such an instance, the identifiers (e.g., indices) for the resultant ray states are the same as the identifiers for the previous ray state, i.e., the indices remain unchanged.

After operation 106, each of memory stores 412 and 414 will include three index entries, and the shared pool will include three “I” and “T” ray states. After each of the resultant ray states have been cleared from the SIMD threads 402₁-402₅, the method may begin at stage 432 in which a determination is made as to which execution type is to be preferred for the next execution operation. As there are an equal number of entries in each memory store 412 and 414 (three), one of the two memory stores may be selected as containing this preferred execution type, and the process proceeds as noted above with the fetching of those indices and assignment of ray states corresponding thereto to the SIMD threads 402₁-402₃. The process may continue until no ray state remains in the shared pool 410.

As above, two or more successive execution operations can be performed at 106, without performing operations 102 and/or 104. In the illustrated embodiment, the application of two execution commands at 106 could be beneficial as the resultant ray states at stage 436 are also T ray state data which could be validly operated upon without the necessity of executing operations 102 and 104.

As with the above first embodiment, one or more new ray states (of either or both execution types) may be loaded into the shared pool 410, their corresponding indices being loaded into the corresponding memory stores 412 and/or 414.

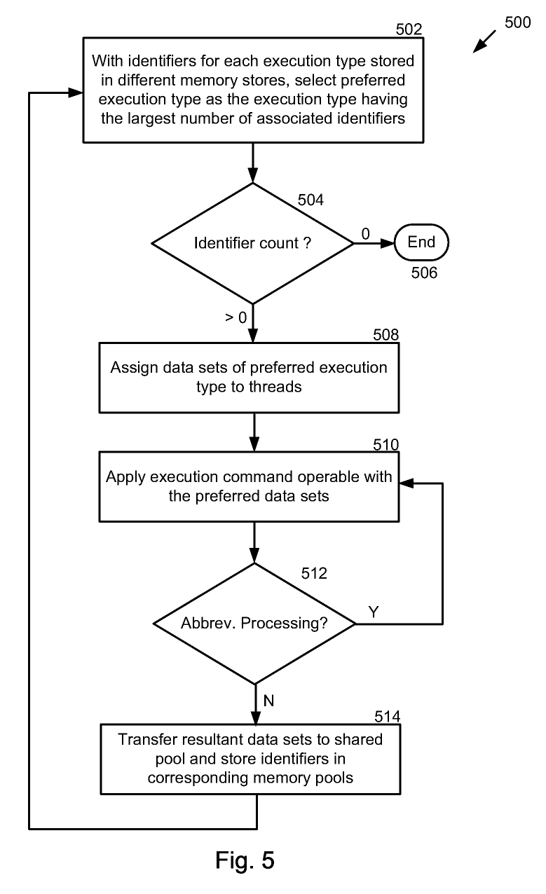

FIG. 5 illustrates an exemplary method of the embodiment shown in FIG. 4. Operations 502, 504, and 506 represents a specific embodiment of operation 102, whereby each of a plurality of memory stores (e.g., memory stores 412 and 414) is used to store identifiers (e.g., indices) for each data set of one execution type. In such an embodiment, operation 102 is implemented by counting the number of identifiers in each of the memory stores 412 and 414, and selecting, as the preferred execution type, the execution type corresponding to the memory store holding the largest number of identifiers. At 504, a determination is made as to whether the count of identifiers in both of the memory stores 412 and 414 is zero. If so, the method concludes at 506. If one or both of the memory stores 412 and 414 includes an identifier count of greater than one, the process continued at 508. Operation 508 represents a specific embodiment of operation 104, in which data sets of the preferred execution type are assigned from one of the plurality of memory stores to threads of the parallel processing architecture. Operation 510 represents a specific embodiment of operation 106, in which one or more execution commands are applied, and one or more resultant data sets are obtained (e.g., ray states obtained at stage 436) responsive to the applied execution command (s), each of the resultant data set having a particular execution type.

At 512, a determination is made as to whether abbreviated processing is to be performed in which a subsequent execution command corresponding to the preferred execution type is applied. If so, the method returns to 510, where a further execution command is applied to the warp of the SIMD. If abbreviated processing is not to be performed, the method continued as 514, where the one or more resultant data sets are transferred from the parallel processing architecture to the pool (e.g., shared pool 410), and an identifier of each resultant data set is stored into a memory pool which stores identifiers for data sets of the same execution type. The illustrated operations continue until no identifiers remain in any of the memory pools.

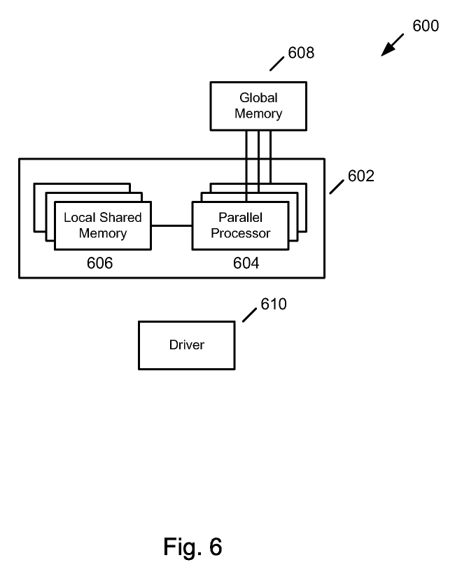

FIG. 6 illustrates an exemplary system operable to perform the operations illustrated in FIGS. 1-5. System 600 includes a parallel processing system 602, which includes one or more (a plurality shown) parallel processing architectures 604, each configured to operate on a predetermined number of threads. Accordingly, each parallel processing architecture 604 may operate in parallel, while the corresponding threads may also operate in parallel. In a particular embodiment, each parallel processing architecture 604 is a single instruction multiple data (SIMD) architecture of a predefined SIMD width or “warp,” for example 32, 64, or 128 threads. The parallel processing system 602 may include a graphics processor, other integrated circuits equipped with graphics processing capabilities, or other processor architectures as well, e.g., the cell broadband engine microprocessor architecture.

The parallel processing system 602 may further include local shared memory 606, which may be physically or logically allocated to a corresponding parallel processing architecture 604. The system 600 may additionally include a global memory 608 which is accessible to each of the parallel processors 604. The system 600 may further include one or more drivers 610 for controlling the operation of the parallel processing system 602. The driver may include one or more libraries for facilitating control of the parallel processing system 602.

In a particular embodiment of the invention, the parallel processing system 602 includes a plurality of parallel processing architectures 604, each parallel processing architecture 604 configured to reduce the divergence of instruction processes executed within parallel processing architectures 604, as described in FIG. 1. In particular, each parallel processing architecture 604 includes processing circuitry for operable to determine, among a plurality of data sets that function as operands for a plurality of different execution commands, a preferred execution type of data set. Further included in each parallel processing architecture 604 is processing circuitry operable to assign, from a pool of data sets, a data set of the preferred execution type to a thread executable by the parallel processing architecture 604. The parallel processing architecture 604 is operable to concurrently execute a plurality of threads, such plurality including the thread which has been assigned the data set of the preferred execution type. The parallel processing architecture 604 additionally includes processing circuitry operable to apply to each of the plurality of threads, an execution command which performs the operation for which the assigned data functions as an operand.

In a particular embodiment, the data sets stored in the pool are of a plurality of different execution types, and in such an embodiment, the processing circuitry operable to determine a preferred execution type includes (i) processing circuitry operable to count, for each execution type, data sets that are resident within the parallel processing architecture and within the pool to determine a total number of data sets for the execution type; and (ii) processing circuitry operable to select, as the preferred execution type, the execution type of the largest number of data sets.

In another embodiment, the apparatus includes a plurality of memory stores, each memory store operable to store an identifier for each data set of one execution type. In such an embodiment, the processing circuitry operable to determine a preferred execution type includes processing circuitry operable to select, as the preferred execution type, an execution type of the memory store which stores the largest number of data set identifiers.

As readily appreciated by those skilled in the art, the described processes and operations may be implemented in hardware, software, firmware or a combination of these implementations as appropriate. In addition, some or all of the described processes and operations may be implemented as computer readable instruction code resident on a computer readable medium, the instruction code operable to control a computer of other such programmable device to carry out the intended functions. The computer readable medium on which the instruction code resides may take various forms, for example, a removable disk, volatile or non-volatile memory, etc., or a carrier signal which has been impressed with a modulating signal, the modulating signal corresponding to instructions for carrying out the described operations.

The terms “a” or “an” are used to refer to one, or more than one feature described thereby. Furthermore, the term “coupled” or “connected” refers to features which are in communication with each other, either directly, or via one or more intervening structures or substances. The sequence of operations and actions referred to in method flowcharts are exemplary, and the operations and actions may be conducted in a different sequence, as well as two or more of the operations and actions conducted concurrently. Reference indicia (if any) included in the claims serves to refer to one exemplary embodiment of a claimed feature, and the claimed feature is not limited to the particular embodiment referred to by the reference indicia. The scope of the claimed feature shall be that defined by the claim wording as if the reference indicia were absent therefrom. All publications, patents, and other documents referred to herein are incorporated by reference in their entirety. To the extent of any inconsistent usage between any such incorporated document and this document, usage in this document shall control.

The foregoing exemplary embodiments of the invention have been described in sufficient detail to enable one skilled in the art to practice the invention, and it is to be understood that the embodiments may be combined. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined solely by the claims appended hereto.

What is claimed is:

1. A method for reducing execution divergence among a plurality of threads concurrently executable by a parallel processing architecture, the method comprising:
determining, among a plurality of data sets that function as operands for a plurality of different execution commands, a preferred execution type of data set;
assigning, from a pool of data sets, a data set of the preferred execution type to a first thread which is to be executed by the parallel processing architecture, the parallel processing architecture operable to concurrently execute a plurality of threads, said plurality of threads including the first thread; and
applying to each of the plurality of threads, an execution command for which the assigned data set functions as an operand.

2. The method of claim 1, wherein the pool comprises local memory storage within the parallel processing architecture.

3. The method of claim 1, wherein each data set comprise a ray state, comprising data corresponding to a ray tested for traversal across a node of a hierarchical tree, and state information about the ray.

4. The method of claim 1, wherein the execution command is selected from the group consisting of a command for performing a node traversal operation and a command for performing a primitive intersection operation.

5. The method of claim 1, wherein the parallel processing architecture comprises a single instruction multiple data (SIMD) architecture.

6. The method of claim 1, wherein applying an execution command comprises applying, to each of the plurality of threads, two successive execution commands for which the data set assigned to the first thread functions as an operand.

7. The method of claim 1, further comprising loading at least one data set into the pool if one of more of the plurality of threads has terminated.

8. The method of claim 1, further comprising repeating the determining, assigning and applying operations at least one time.

9. The method of claim 1, wherein each of the plurality of data sets comprises one of M predefined execution types;
wherein the parallel processing architecture is operable to execute a plurality of N parallel threads; and
wherein the pool comprises storage for storing at least [M(N−1)+1]−N data sets.

10. The method of claim 9,
wherein each of the plurality of data sets comprises one of two predefined execution types;
wherein the parallel processing architecture is operable to execute a plurality of N parallel threads; and
wherein the pool comprises storage for storing at least N−1 data sets.

11. The method of claim 1, wherein the data sets stored in the pool are of a plurality of different execution types,
wherein determining a preferred execution type comprises:
for each execution type, counting data sets that are resident within the parallel processing architecture and within the pool to determine a total number of data sets for the execution type; and
selecting, as the preferred execution type, the execution type of the largest number of data sets.

12. The method of claim 11, wherein the number of data sets resident with the parallel processing apparatus for each execution type is multiplied by a weighting factor.

13. The method of claim 1, wherein the parallel processing architecture includes a thread having a non-preferred data set which is not of the preferred execution type, and wherein assigning comprises:
storing the non-preferred data set into the pool; and
replacing the non-preferred data set with a data set of the preferred execution type.

14. The method of claim 1, further comprising a plurality of memory stores, each memory store operable to store an identifier for each data set of one execution type;
wherein determining a preferred execution type comprises selecting, as the preferred execution type, an execution type of the memory store which comprises the largest number of data set identifiers.

15. The method of claim 14, wherein assigning comprises assigning a data set of the preferred execution type from the pool to a respective thread of the parallel processing architecture.

16. The method of claim 15, further comprising:
obtaining one or more resultant data sets responsive to the applied execution command, each of the resultant data set having a particular execution type;
transferring the one or more resultant data sets from the parallel processing architecture to the pool; and
storing an identifier for each resultant data set into a memory pool operable for storing identifiers for data sets of the same execution type.

17. A computer program product, resident on a computer readable medium, for executing instructions to reduce execution divergence among a plurality of threads concurrently executable by a parallel processing architecture, the computer program product comprising:
instruction code for determining, among a plurality of data sets that function as operands for a plurality of different execution commands, a preferred execution type of data set;
instruction code for assigning, from a pool of data sets, a data set of the preferred execution type to a first thread which is to be executed by the parallel processing architecture, the parallel processing architecture operable to concurrently execute a plurality of threads, including the first thread; and
instruction code for applying to each of the plurality of threads, an execution command which performs the operation for which the assigned data set functions as an operand.

18. The computer program product of claim 17, wherein the data sets stored in the pool are of a plurality of different execution types,
wherein the instruction code for determining a preferred execution type comprises:
instruction code for counting, for each execution type, data sets that are resident within the parallel processing architecture and within the pool to determine a total number of data sets for the execution type; and
instruction code for selecting, as the preferred execution type, the execution type of the largest number of data sets.

19. The computer program product of claim 17, further comprising a plurality of memory stores, each memory store operable to store an identifier for each data set of one execution type;
wherein the instruction code for determining a preferred execution type comprises instruction code for selecting, as the preferred execution type, an execution type of the memory store which comprises the largest number of data set identifiers.

20. An apparatus, comprising:
a parallel processing architecture configured for reducing execution divergence among a plurality of threads concurrently executable thereby, the parallel processing architecture including:
processing circuitry operable to determine, among a plurality of data sets that function as operands for a plurality of different execution commands, a preferred execution type of data set;
processing circuitry operable to assign, from a pool of data sets, a data set of the preferred execution type to a first thread which is to be executed by the parallel processing architecture, wherein the parallel processing architecture is operable to concurrently execute a plurality of threads, including the first thread; and
processing circuitry operable to apply to each of the plurality of threads, an execution command which performs the operation for which the assigned data set functions as an operand.

21. The apparatus of claim 20, wherein the data sets stored in the pool are of a plurality of different execution types,
wherein the processing circuitry operable to determine a preferred execution type includes:
processing circuitry operable to count, for each execution type, the number of data sets that are resident within the parallel processing architecture and within the pool to determine a total number of data sets for the execution type; and
processing circuitry operable to select, as the preferred execution type, the execution type of the largest number of data sets.

22. The apparatus of claim 20, further comprising a plurality of memory stores, each memory store operable to store an identifier for each data set of one execution type;
wherein the processing circuitry operable to determine a preferred execution type comprises processing circuitry operable to select, as the preferred execution type, an execution type of the memory store which comprises the largest number of data set identifiers.
